(19) United States
(12) Patent Application Publication
(10) Pub. No.: US 2026/0371385 A1
(43) Pub. Date: Nov. 19, 2026

(54) EFFICIENT POSITIONING REFERECE SIGNAL DETECTION FOR SIDELINK POSITIONING IN UNLICENSED SPECTRUM

(71) Applicant: Nokia Technologies Oy, Espoo (FI)

(72) Inventors: Yong LIU, Shanghai (CN); Diomidis MICHALOPOULOS, Munich (DE); Taylan SAHIN, Munich (DE); Torsten WILDSCHEK, Gloucester (GB); Stepan KUCERA, Munich (DE); Renato Barbosa ABREU, Aalborg (DK)

(21) Appl. No.: 19/100,213

(22) PCT Filed: Aug. 10, 2022
(86) PCT No.: PCT/CN2022/111335

§ 371 Date: Jan. 31, 2025

(51) Int. Cl. H04W 74/0808; H04W 64/00; H04W 76/23; H04W 92/18

(52) U.S. Cl. CPC H04W 74/0808; H04W 64/006; H04W 76/23; H04W 92/18

(57) ABSTRACT

Example embodiments of the present disclosure relate to devices, methods, apparatuses and computer readable media supporting efficient positioning reference signal detection for sidelink positioning in an unlicensed spectrum. A first terminal device in a radio access network may be configured to initiate a first listen before talk procedure before transmitting a sidelink positioning reference signal to a second terminal device in the radio access network in an unlicensed spectrum during a sidelink positioning session, transmit positioning related control information to the second terminal device in a licensed spectrum, and transmit the sidelink positioning reference signal in the unlicensed spectrum in response to the first listen before talk procedure ending successfully. The positioning related control information comprises an indication for the second terminal device to receive a notification of whether the first listen before talk procedure is successful or to perform a second listen before talk procedure.

### TECHNICAL FIELD

Various exemplary embodiments described herein generally relate to communication technologies, and more particularly, to devices, methods, apparatuses and computer readable media supporting efficient positioning reference signal (PRS) detection for sidelink positioning in an unlicensed spectrum.

### BACKGROUND

Certain abbreviations that may be found in the description and the figures are herewith defined as follows:

| | |
|---|---|
| 3GPP | Third Generation Partner Project |
| CCA | Clear Channel Assessment |
| COT | Channel Occupancy Time |
| CW | Contention Window |
| DMRS | Demodulation Reference Signal |
| gNB | next Generation Node-B |
| LBT | Listen Before Talk |
| NR | New Radio |
| PRS | Positioning Reference Signal |
| PSCCH | Physical Sidelink Control Channel |
| PSFCH | Physical Sidelink Feedback Channel |
| PSSCH | Physical Sidelink Shared Channel |
| Rx | Receiver |
| SL | Sidelink |
| SCI | Sidelink Control Information |
| Tx | Transmitter |
| UE | User Equipment |

Recently 3GPP approved a study item on enhanced positioning, including sidelink positioning as a crucial part. Potential solutions for sidelink positioning include relative positioning, ranging and absolute positioning. In the study item, an enhancement to extend the sidelink positioning to an unlicensed spectrum is considered.

### SUMMARY

In general, example embodiments of the present disclosure provide a solution of efficient positioning reference signal detection for sidelink positioning in an unlicensed spectrum.

In a first aspect, an example embodiment of a first terminal device in a radio access network is provided. The first terminal device may comprise at least one processor and at least one memory storing instructions. The instructions, when executed by the at least one processor, may cause the first terminal device at least to initiate a first listen before talk procedure before transmitting a sidelink positioning reference signal to a second terminal device in the radio access network in an unlicensed spectrum during a sidelink positioning session, transmit positioning related control information to the second terminal device in a licensed spectrum, and transmit the sidelink positioning reference signal in the unlicensed spectrum in response to the first listen before talk procedure initiated by the first terminal device ending successfully. The positioning related control information may comprise an indication for the second terminal device to receive a notification of whether the first listen before talk procedure initiated by the first terminal device is successful or to perform a second listen before talk procedure.

In a second aspect, an example embodiment of a second terminal device in a radio access network is provided. The second terminal device may comprise at least one processor and at least one memory storing instructions. The instructions, when executed by the at least one processor, may cause the second terminal device at least to receive positioning related control information from a first terminal device in the radio access network over sidelink in a licensed spectrum, and perform sidelink positioning reference signal detection in an unlicensed spectrum at a timing determined based on the positioning related control information. The positioning related control information may comprise an indication for the second terminal device to receive a notification of whether a first listen before talk procedure initiated by the first terminal device is successful or to perform a second listen before talk procedure.

Example embodiments of methods, apparatuses, and computer readable media are also provided. Such example embodiments generally correspond to the above example embodiments of the devices, and a repetitive description thereof is omitted here for convenience.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 is a schematic diagram illustrating a communication network in which example embodiments of the present disclosure can be implemented.

FIG. 2A is a schematic diagram illustrating a channel occupancy time duration obtained through a listen before talk procedure.

FIG. 2B is a schematic flowchart illustrating a Type 1 listen before talk procedure.

FIG. 3 is a schematic message flowchart illustrating sidelink communications between multiple user equipments.

FIG. 4 is a schematic message flowchart illustrating a process according to an example embodiment of the present disclosure.

FIG. 5 is a schematic block diagram illustrating an apparatus according to an example embodiment of the present disclosure.

FIG. 6 is a schematic block diagram illustrating an apparatus according to an example embodiment of the present disclosure.

FIG. 7 is a schematic block diagram illustrating a device according to an example embodiment of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

As used herein, the term “network device” refers to any suitable entities or devices that can provide cells or coverage, through which the terminal device can access the network or receive services. The network device may be commonly referred to as a base station. The term “base station” used herein can represent a node B (NodeB or NB), an evolved node B (eNodeB or eNB), or a gNB. The base station may be embodied as a macro base station, a relay node, or a low power node such as a pico base station or a femto base station. The base station may consist of several distributed network units, such as a central unit (CU), one or more distributed units (DUs), one or more remote radio heads (RRHs) or remote radio units (RRUs). The number and functions of these distributed units depend on the selected split RAN architecture.

As used herein, the term “terminal device” or “user equipment” (UE) refers to any entities or devices that can wirelessly communicate with the network devices or with each other. Examples of the terminal device can include a mobile phone, a mobile terminal (MT), a mobile station (MS), a subscriber station (SS), a portable subscriber station (PSS), an access terminal (AT), a computer, a wearable device, an on-vehicle communication device, a machine type communication (MTC) device, a device to device (D2D) communication device, a vehicle to everything (V2X) communication device, a sensor and the like. The term “terminal device” can be used interchangeably with a UE, a user terminal, a mobile terminal, a mobile station, or a wireless device.

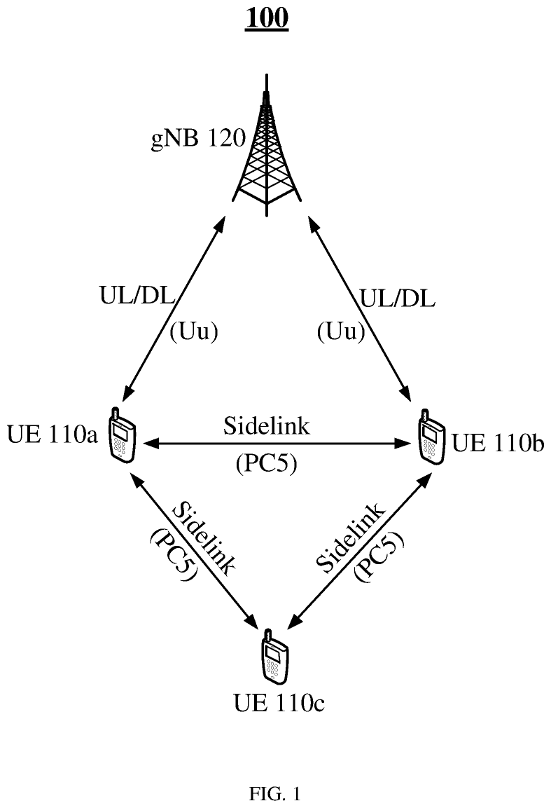

FIG. 1 illustrates an example communication network 100 in which exemplary embodiments of the present disclosure may be implemented. The communication network 100 may be a radio access network (RAN), e.g., a 5G New Radio (NR) RAN. As shown in FIG. 1, the communication network 100 may include a plurality of user equipments (UEs) 110a-110c (each also individually referred to as UE 110 or collectively as UEs 110) and a base station 120 in communication with one or more of the plurality of UEs 110a-110c. The base station 120 is shown as a 5G base station gNB, but it may also be implemented as other base stations like a Long Term Evolution (LTE) base station eNB, a beyond 5G base station or a future base station. The base station 120 may communicate with one or more of the UEs 110 via uplink (UL) and downlink (DL) channels over a Uu interface. In some example embodiments, the base station 120 may implement other radio access technologies to communicate with one or more of the UEs 110.

The UEs 110 may be a mobile phone, a vehicle mounted terminal, a roadside unit or the like. In addition to communicating with the base station 120, the UEs 110 may also perform direct communication, referred to as sidelink (SL) communication, to each other over for example a PC5 interface. The UEs 110 each may function as a SL transmitter (Tx) UE to transmit transmissions on the sidelink or a SL receiver (Rx) UE to receive transmissions on the sidelink. The Tx UE may transmit sidelink transmissions to one or more Rx UEs by unicast, groupcast or broadcast with or without control of the network. For example, the sidelink may be established between the UEs 110 of which all are within the network coverage (in-coverage scenario), all are outside the network coverage (out-of-coverage scenario), or one or more are within the network coverage while the others are outside the network coverage (partial-coverage scenario).

The UEs 110 may use different spectrum for different sidelink communications. For example, the UEs 110 may transmit a physical sidelink control channel (PSCCH) and a physical sidelink shared channel (PSSCH) in a licensed spectrum e.g. LTE or NR bands, and transmit a sidelink reference signal e.g. a sidelink positioning reference signal (SL-PRS) in an unlicensed spectrum. The unlicensed spectrum may refer to any frequency band(s) that does not require a license from an appropriate regulating entity, such that the frequency band(s) are open to use by any devices, not just devices that have a license to use the particular frequency band(s). Examples of the unlicensed spectrum that have worldwide availability include 2.4 GHz, 5 GHz and 60 GHz.

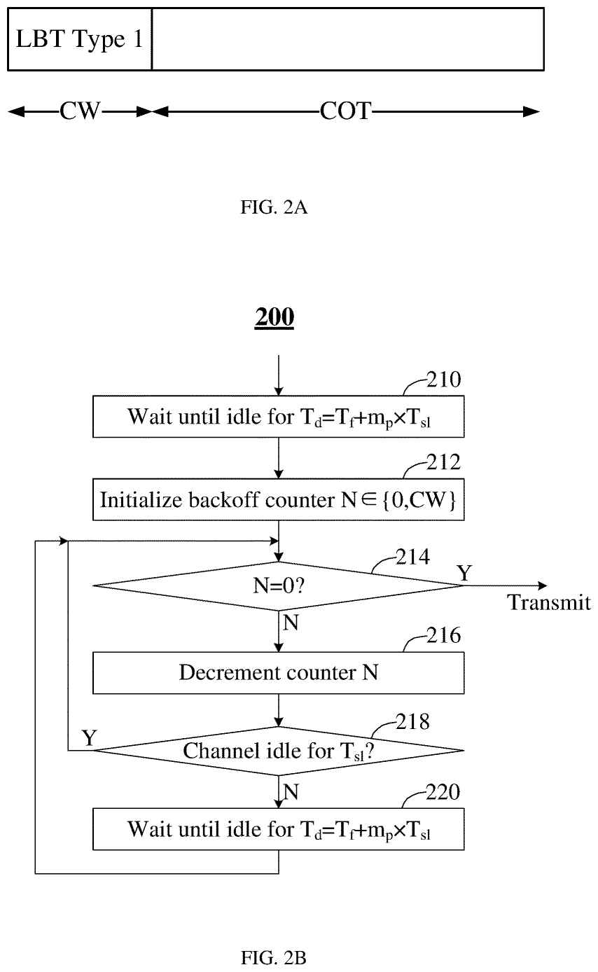

The unlicensed spectrum may also be used by other communication systems. For example, the 2.4 GHz and 5 GHz frequency bands are used for WiFi communication. Considering coexistence with the other systems, a Tx UE needs to perform a clear channel assessment procedure to evaluate whether a channel in the unlicensed spectrum is available or not before the Tx UE initiates a sidelink transmission in the unlicensed spectrum. A Listen Before Talk (LBT) channel access mechanism is introduced for the channel availability assessment. When the Tx UE intends to initiate a sidelink transmission, it performs an “extended” LBT procedure to evaluate whether the channel is available during a contention window (CW). The “extended” LBT procedure is commonly known as LBT Type 1 or LBT Cat. 4. If the channel is available for the duration of the contention window, the Tx UE acquires the “right” to access the channel for a certain period of time, denoted as channel occupancy time (COT), immediately after the contention window. FIG. 2A shows a schematic diagram of the contention window (CW) and the channel occupancy time (COT). The Tx UE may transmit the sidelink transmission upon it acquires the COT.

FIG. 2B is a schematic flowchart illustrating a Type 1 LBT procedure 200. In the LBT procedure 200, the UE observes the channel as a number of consecutive clear channel assessment (CCA) slots, also referred to as sensing slots. In sub-7 GHz, the CCA slots have a duration Tₛₗ of 9 μs. The UE deems the channel as idle/available in a CCA slot if the measured power (i.e., the collected energy) during the CCA slot is below a predetermined threshold.

Referring to FIG. 2B, when the UE senses the channel to be idle for a defer period T_{d} at 210, the UE may initialize at 212 a backoff counter N for the Type 1 LBT procedure with a rando number uniformly distributed between 0 and CW. The defer period T_{d} may consist of a duration T_{f}=16 us immediately followed by mₚ consecutive slot durations Tₛₗ.

At 214, the UE may determine whether the backoff counter N equals to zero or not. If the backoff counter N equals to zero, the UE acquires the right to access the channel for the channel occupancy time (COT) and it can transmit the sidelink transmission in the unlicensed spectrum immediately.

If the backoff counter N is larger than zero at 214, the UE may decrement the backoff counter N by one at 216 and sense the channel for an additional slot duration Tₛₗ at 218. If the channel is idle for the additional slot duration Tₛₗ, the process 200 goes back to the step 214. If the channel is busy (the collected energy is higher than or equal to the predetermined energy threshold) for the additional slot duration Tₛₗ, the UE may sense the channel at 220 until an additional defer period T_{d} is detected to be idle, and then the process 200 may go back to the step 214.

For synchronized cellular communication systems, transmissions can only start at the beginning of a slot (e.g., a NR slot) or a symbol within a slot (e.g., an OFDM symbol within a NR slot). At 214, if the backoff counter N equals to zero (i.e., the Type 1 LBT procedure ends), the UE acquires the right to access the channel. In an example, if the UE is going to start transmitting a transmission at the beginning of a slot or a symbol (the slot or the symbol is after the Type 1 LBT procedure ends), it performs an additional short/reduced LBT procedure (e.g., checks if the channel is idle for an additional duration of a defer period T_{d}) right before the slot or the symbol. The UE can start transmitting at the beginning of the slot or the symbol after verifying the channel is idle for the duration. In another example, the UE senses the channel additionally when the UE is ready to transmit a transmission. The UE may transmit the transmission on the channel if the channel is sensed to be idle at least in a CCA slot duration Tₛₗ.

In the present disclosure, when the backoff counter of a Type 1 LBT procedure decreases to 0, it is deemed that the Type 1 LBT procedure ends or the Type 1 LBT procedure is successful. The UE performs the Type 1 LBT procedure based on a channel access priority class (CAPC) associated with the sidelink transmission to be transmitted in the unlicensed spectrum. The above-mentioned parameters CW, mₚ, T_{d} and COT for the Type 1 LBT procedure may be determined based on the CAPC. The UE acquires the COT when the Type 1 LBT procedure is successfully completed, and the acquired COT is valid even in a case where the UE pauses its transmission. If the UE wants to initiate a new transmission within the COT, it is still required to perform a “reduced” (or short) LBT procedure. The “reduced” LBT procedure, commonly known as LBT Type 2, has the following variants:
Type 2A (25 μs LBT, also referred to as LBT Cat. 2)—for sidelink transmissions within the initiating device acquired COT (in case a gap between two sidelink transmissions is larger than or equal to 25 μs, as well for sidelink transmissions following another sidelink transmission);
Type 2B (16 μs LBT, also referred to as LBT Cat. 2)—for sidelink transmissions within the initiating device acquired COT (only used for sidelink transmissions following another sidelink transmission with a gap equal to 16 μs); and
Type 2C (no LBT, also referred to as LBT Cat. 1)—for sidelink transmission following another sidelink transmission with a gap less than 16 μs and the allowed duration of the sidelink transmission is less than or equal to 584 μs.

The initiating UE (i.e., the UE initiating the sidelink transmission) can share its acquired COT with its intended receiver (the responding UE). For this purpose, the initiating UE may inform, e.g. via a control signaling, the responding UE about the duration of the COT. Then the responding UE may use this information to decide which type of LBT it should apply upon performing a transmission for which the intended receiver is the initiating UE. In case either the responding UE's transmission falls outside the COT or the responding UE wants to perform a new transmission to another UE, then the responding UE will have to acquire a new COT using the LBT Type 1 with an appropriate CAPC.

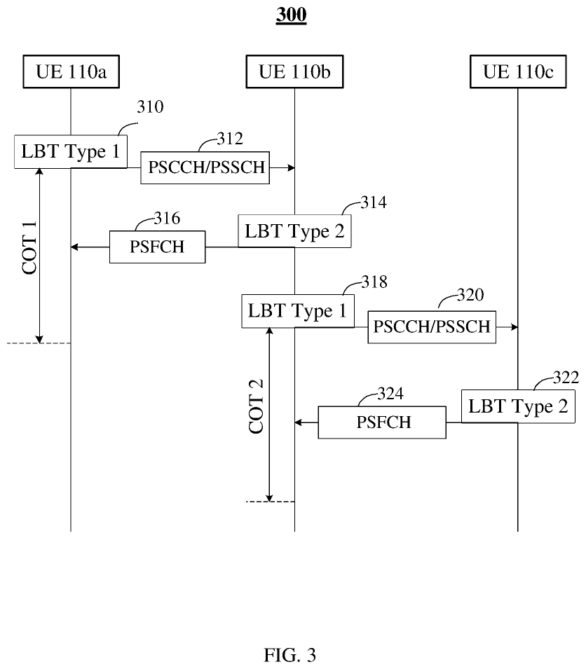

FIG. 3 illustrates an example of sidelink communications 300 between multiple UEs. Referring to FIG. 3, a first UE 110a may perform the Type 1 LBT procedure to obtain a first COT at 310 and then transmit at 312 a sidelink transmission via PSCCH/PSSCH to a second UE 110b within the first COT. The first UE 110a may also share the first COT with the second UE 110b via a control signaling. Within the first COT, the second UE 110b may perform the “reduced” LBT (LBT Type 2) to confirm channel availability at 314 and transmit at 316 a hybrid automatic retransmission request (HARQ) feedback via a physical sidelink feedback channel (PSFCH) to the first UE 110a, in response to the PSCCH/PSSCH transmission received from the first UE 110a. The PSFCH is introduced to enable HARQ feedback over sidelink from a UE that is the intended recipient of a sidelink transmission (i.e., the Rx UE) to a UE that performed the sidelink transmission (i.e., the Tx UE). If the Rx UE receives and decodes the sidelink transmission successfully, it generates a positive HARQ acknowledgement (ACK) and sends the HARQ ACK on the PSFCH to the Tx UE to confirm successful receipt of the sidelink transmission. If the Rx UE fails to receive or decode the sidelink transmission, it generates a negative HARQ acknowledgement (NACK) and sends the HARQ NACK on the PSFCH to the Tx UE to request for a retransmission of the sidelink transmission.

If the second UE 110b wants to send a sidelink transmission to a third UE 110c, the second UE 110b may perform the Type 1 LBT procedure to obtain a second COT at 318 and then transmit at 320 the sidelink transmission on e.g. PSCCH/PSSCH to the third UE 110c. The second UE 110b may also share the second COT with the third UE 110c via a control signaling. Within the second COT, the third UE 110c may perform the Type 2 LBT procedure to confirm channel availability at 322 and transmit at 324 an HARQ feedback on the PSFCH to the second UE 110b, in response to the sidelink transmission received from the second UE 110b.

Because of the listen-before talk requirements when operating in the unlicensed spectrum, there will be some uncertainty on whether or not a given transmission can take place when it is intended. For example, in a sidelink positioning procedure, it is uncertain at the Tx UE when a positioning reference signal (PRS) can be transmitted, which leads to the fact that the time when the corresponding Rx UE needs to detect the PRS is also uncertain. To overcome the uncertainty on when to detect the PRS, the Rx UE may apply continuous PRS sequence detection. This, however, requires high power consumption. Another option for the Rx UE is to perform PRS sequence detection only at a slot/symbol indicated from the Tx UE. In this case, however, the Tx UE may not be able to catch the channel before the indicated slot/symbol, which results in a high latency.

According to aspects of the present disclosure, a mechanism of efficient PRS detection for sidelink positioning in the unlicensed spectrum is provided. In some example embodiments, a Tx UE can dynamically determine an efficient way for a Rx UE to detect the sidelink PRS transmitted in the unlicensed spectrum. For example, if a delay between PSSCH and associated PSFCH is longer than remaining time of the LBT procedure performed at the Tx UE for the PRS transmission, the Tx UE may use the modified PSFCH to inform the Rx UE of whether the LBT procedure performed at the Tx UE is successful or not. In another example, if the Tx UE and the Rx UE observe the same radio environment, the Tx UE may request the Rx UE to perform the same LBT procedure as the LBT procedure performed at the Tx UE to predict the timing of the PRS transmission. The Tx UE can transmit the PRS to the Rx UE in the unlicensed spectrum and transmit positioning related control information to the Rx UE in the licensed spectrum, so that the positioning related control information can be transmitted before the Tx UE acquires the right to transmit the PRS in the unlicensed spectrum. The proposed mechanism can enable the Rx UE to detect the PRS promptly in the unlicensed spectrum with reduced complexity and power consumption.

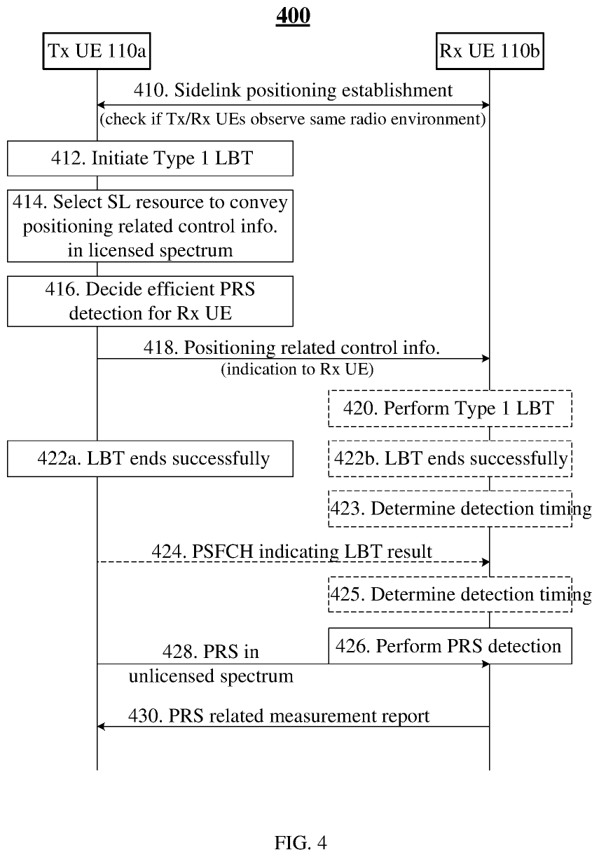

FIG. 4 illustrates a process 400 of sidelink PRS transmission and detection in the unlicensed spectrum according to an example embodiment of the present disclosure. The process 400 may be performed by a Tx UE to transmit the sidelink PRS and one or more Rx UEs to receive the sidelink PRS. The Tx and Rx UEs may include a plurality of means, modules, components or elements for performing operations in the process 400, and the means, modules, components or elements may be implemented in various manners, including but not limited to software, hardware, firmware, or any combination thereof.

Referring to FIG. 4, at 410, the Tx UE 110a may perform a sidelink positioning establishment procedure with the Rx UE 110b in response to a request for sidelink positioning from a higher layer. The sidelink positioning request may be associated with a procedure for positioning the Tx UE 110a or the Rx UE 110b. In the sidelink positioning establishment procedure, the Tx UE 110a may determine whether the Tx UE 110a and the Rx UE 110b observe the same radio environment.

In an example embodiment, the Tx UE 110 may determine whether the Tx UE 110a and the Rx UE 110b are in the same radio environment based on a distance between the Tx UE 110a and the Rx UE 110b. The Tx UE 110a may estimate a rough distance between the Tx UE 110a and the Rx UE 110b by exploiting a reference signal received from the Rx UE 110b, e.g., a demodulation reference signal (DMRS) received on the PSSCH from the Rx UE 110b. If the distance is less than or equal to a configured threshold, the Tx UE 110a determines that the Tx UE 110a and the Rx UE 110b observe the same radio environment. In the sidelink positioning establishment procedure, the Tx UE 110a and the Rx UE 110b can exchange information via PSSCHs transmitted in the licensed spectrum. Since the carrier is in the licensed spectrum, the distance estimation is rough, which is not accurate enough for positioning but is acceptable for the radio environment estimation.

In another example embodiment, the Tx UE 110 may determine whether the Tx UE 110a and the Rx UE 110b are in the same radio environment based on channel measurements made by the Tx UE 110a and the Rx UE 110b. In the sidelink positioning establishment procedure, the Tx UE 110a and the Rx UE 110b can negotiate when and how to measure channels in the unlicensed spectrum and then measure the channels in the unlicensed spectrum as negotiated. The Rx UE 110b may send its measurement to the Tx UE 110a e.g. via the PSSCH in the licensed spectrum. If the measurement result of the Rx UE 110b is identical to the measurement result of the Tx UE 110a, the Tx UE 110a can determine that the Tx UE 110a and the Rx UE 110b are in the same radio environment. It would be appreciated that the Tx UE 110a and the Rx UE 110b may also use other solutions to determine if they are in the same radio environment, and the example embodiments are not limited to the examples described above.

At 412, the Tx UE 110a may initiate the Type 1 LBT procedure. Before initiating the Type 1 LBT procedure, the Tx UE 110a may determine parameters for the Type 1 LBT procedure. For example, the Tx UE 110a may determine the contention window (CW) value, the deferred period T_{d}, the channel occupancy time (COT) value for the Type 1 LBT procedure based on a channel access priority class (CAPC) associated with the sidelink positioning reference signal (PRS). The Type 1 LBT procedure may be performed as described above with reference to FIG. 2B, and a repetitive description thereof is omitted here for convenience.

At 414, the Tx UE 110a may select a sidelink resource for transmission of positioning related control information in the licensed spectrum. In an example embodiment, the positioning related control information may be transmitted as a part of sidelink control information (SCI). The SCI may have a two stage SCI structure, including a first stage SCI carried on the PSCCH and a second stage SCI carried on the PSSCH, to support a size difference between SCIs for various NR sidelink service types. The Tx UE 110a may select a PSCCH or/and PSSCH resource for transmission of the SCI containing the positioning related control information.

Two radio resource allocation modes may be configured for the Tx UE 110a. In a first mode, the network is responsible for sidelink resource allocation to the Tx UE 110a. The Tx UE 110a may transmit a sidelink scheduling request (SL-SR) to the base station 120, and the base station 120 may send a resource allocation to the Tx UE 110a in response to the received SL-SR. In a second mode, the Tx UE 110a can autonomously select a sidelink resource from a sidelink resource pool(s) configured for the Tx UE 110a. For example, the Tx UE 110a may first perform a sensing procedure over the configured sidelink resource pool to obtain knowledge of the reserved resources, and then select a sidelink resource based on the sensing result.

In example embodiments, the Tx UE 110a may perform the operation 412 before the operation 414, or perform the operations 412, 414 in parallel. When the sidelink resource for the transmission of the positioning related control information is selected, the Type 1 LBT procedure may be still in progress. In another example embodiment, the Tx UE 110a may perform the operation 412 after the operation 418. The Tx UE 110a may initiate the Type 1 LBT procedure after transmitting the positioning related control information to the Rx UE 110b using the selected sidelink resource in the licensed spectrum.

At 416, the Tx UE 110a may decide an efficient way of sidelink PRS detection for the Rx UE 110b. As mentioned above, because of the LBT procedure, when the Tx UE 110a transmits the sidelink PRS is uncertain. The Tx UE 110a can dynamically determine the efficient PRS detection for the Rx UE 110b based on for example at least one of progress of the Type 1 LBT procedure initiated at the Tx UE 110a, a delay between the selected sidelink resource for transmission of the positioning related control information and a physical sidelink feedback channel (PSFCH) resource associated with the selected sidelink resource, the radio environment of the Tx UE 110a and the Rx UE 110b, or additional factors.

In an example embodiment, if the delay between the selected sidelink resource for transmission of the positioning related control information and the PSFCH resource associated with the selected sidelink resource is longer than estimated remaining time of the Type 1 LBT procedure initiated at the Tx UE 110a, the Tx UE 110a can estimate that the Type 1 LBT procedure would end before an HARQ feedback is transmitted on the PSFCH. Then the Tx UE 110a can decide to reuse the PSFCH resource to notify the Rx UE 110 whether the Type 1 LBT procedure is successful or not. The estimated remaining time of the Type 1 LBT procedure may be determined as at least n times of the CCA sensing slot duration Tₛₗ(n×Tₛₗ) where n is the current value of the backoff counter N. The delay between the selected sidelink resource and the associated PSFCH resource may be determined from a PSSCH-to-PSFCH time gap parameter K configured via an information element sl-MinTimeGapPSFCH for the Tx UE 110a and the Rx UE 110b. For example, for the selected sidelink resource with its last symbol in a slot s, the associated PSFCH resource is expected in a slot s+a where a is the smallest integer larger than or equal to K.

In an example, external interference may also be considered when the Tx UE 110a decide whether to reuse the PSFCH to notify the Rx UE 110 whether the Type 1 LBT procedure is successful or not. If there is almost no or sporadic external interference, the probability that the Rx UE 110b successfully receives the sidelink transmission from the Tx UE 110a is high. Therefore, the Rx UE 110b does not need to use the PSFCH to confirm successful receipt of the sidelink transmission, and the Tx UE 110a can reuse the PSFCH to notify the Rx UE 110b of whether the LBT procedure initiated at the Tx UE 110a is successful or not. And if there is almost no or sporadic external interference, the channel is idle most of the time within the delay.

In an example embodiment, if the Tx UE 110a and the Rx UE 110b are in the same radio environment, the Tx UE 110a may decide at 416 to indicate the Rx UE 110b to perform the Type 1 LBT procedure to predict the timing of PRS transmission from the Tx UE 110a. The Rx UE 110b may perform the Type 1 LBT procedure in synchronization with the Type 1 LBT procedure performed at the Tx UE 110a, which will be described in detail below. For convenience of description, the LBT procedure performed at the Tx UE 110a will be referred to as first LBT procedure, and the LBT procedure performed at the Rx UE 110b will be referred to as second LBT procedure.

At 418, the Tx UE 110a may transmit the positioning related control information to the Rx UE 110b using the selected sidelink resource in the licensed spectrum. As mentioned above, the positioning related control information may be contained in the sidelink control information (SCI), and the positioning related control information may be transmitted to the Rx UE 110b before the first LBT procedure initiated at the Tx UE 110a ends.

Depending on the decision made at the operation 416, the positioning related control information may include an indication for the Rx UE 110b to receive a notification of whether the first LBT procedure is successful or not, or an indication for the Rx UE 110b to perform the second LBT procedure. The indication for the Rx UE 110b to perform the second LBT procedure may include one or more parameters related to the first LBT procedure performed at the Tx UE 110a. In an example, the one or more parameters related to the first LBT procedure may include for example at least one of the starting or continuing time of the first LBT procedure, a current value of the backoff counter of the first LBT procedure, the defer period of the first LBT, the energy threshold for the first LBT procedure, or the channel access priority class for the first LBT procedure.

If the positioning related control information transmitted at 418 includes the indication for the Rx UE 110b to perform the second LBT procedure, the Rx UE 110b may perform the second LBT procedure at 420. The UE 110b may perform the second LBT procedure using the one or more parameters of the first LBT procedure such that the first LBT procedure and the second LBT procedure are performed synchronously with each other. For example, the Rx UE 110b may initiate the backoff counter N for the second LBT procedure with the current backoff counter value of the first LBT procedure.

At 422a, the first LBT procedure performed at the Tx UE 110a ends successfully. If the Rx UE 110b was indicated to perform the second LBT procedure at 418, the second LBT procedure performed at the Rx UE 110b also ends successfully at the same time at 422b because the Tx UE 110a and the Rx UE 110b are in the same radio environment and the second LBT procedure is performed synchronously with the first LBT procedure.

When the second LBT procedure performed at the Rx UE 110b ends successfully, the Rx UE 110b may determine at 423 the timing for the sidelink positioning reference signal (PRS) detection. In an example, the Rx UE 110b may decide to perform the sidelink PRS detection in the unlicensed spectrum immediately after the second LBT procedure ends successfully. In another example, the Rx UE 110b may decide to start performing the sidelink PRS detection in the unlicensed spectrum at the beginning of a slot (e.g., a NR slot) or a symbol within a slot (e.g., an OFDM symbol within a NR slot). The slot or the symbol is after the second LBT procedure ends successfully. Further, because the Tx UE 110a and the Rx UE 110b are in the same radio environment, the Rx UE 110b may perform an additional short/reduced LBT procedure (e.g., checks if the channel is idle for an additional duration of a defer period Ta) right before the slot or the symbol. The Rx UE 110b may start performing the sidelink PRS detection in the unlicensed spectrum at the beginning of the slot or the symbol after verifying the channel is idle for the duration.

If the Tx UE 110a indicates the Rx UE 110b to receive a notification of whether the first LBT procedure is successful or not at 418, the Rx UE 110b knows that the PSFCH resource associated with transmission of the positioning related control information is used to convey the notification, and then the Rx UE 110b would not transmit the HARQ feedback to the Tx UE 110a on the PSFCH resource associated with the positioning related control information. Instead, at 424, the Rx UE 110b would receive the notification transmitted from the Tx UE 110a on the PSFCH resource.

Since the delay between the transmission of the positioning related control information and the associated PSFCH resource is longer than the estimated remaining time of the first LBT procedure initiated at the Tx UE 110a, the first LBT procedure may have already successfully ended when the Tx UE 110a transmits the notification on the PSFCH resource to the Rx UE 110b. Then the Tx UE 110a may transmit HARQ ACK on the PSFCH resource to the Rx UE 110b, and the Rx UE 110b can determine from the HARQ ACK that the first LBT procedure is successful.

If the first LBT procedure has not yet ended at the timing of the PSFCH resource, for example because the channel is busy in a sensing slot and the Tx UE 110a has to sense the channel to be idle for an additional defer period, the Tx UE 110a may transmit HARQ NACK on the PSFCH resource to the Rx UE 110b. The Rx UE 110b can determine from the HARQ NACK that the first LBT procedure has not ended successfully.

When the notification represented by the HARQ feedback is received on the PSFCH, the Rx UE 110b may determine at 425 the timing for the sidelink positioning reference signal (PRS) detection based on the received notification. In an example, if the received notification indicates that the first LBT procedure initiated by the Tx UE 110a ends successfully, the Rx UE 110b may decide to perform the sidelink PRS detection in the unlicensed spectrum immediately. In another example, if the received notification indicates that the first LBT procedure initiated by the Tx UE 110a ends successfully, the Rx UE 110b may decide to start performing the sidelink PRS detection in the unlicensed spectrum at the beginning of a slot (e.g., a NR slot) or a symbol within a slot (e.g., an OFDM symbol within a NR slot). The slot or the symbol is after that the notification is received at the Rx UE 110b. If the received notification indicates that the first LBT procedure initiated by the Tx UE 110a has not yet ended, the Rx UE 110b may decide not to detect the sidelink PRS transmitted from the Tx UE 110a in the unlicensed spectrum. In this case, the operations 418, 424 and 425 may be performed repeatedly until the first LBT procedure ends successfully.

Although the PSFCH resource associated with the positioning related control information is used for transmission of the LBT ending notification in the above example embodiments, the present disclosure is not limited to it. In an example embodiment, the positioning related control information may further include a resource allocation for transmission of the LBT ending notification. The Rx UE 110b can use the PSFCH resource to confirm receipt of the positioning related control information as usual, and the Tx UE 110a can transmit the LBT ending notification to the Rx UE 110b based on the resource allocation.

In response to the notification of the first LBT procedure ending successfully or in response to the second LBT procedure ending successfully, the Rx UE 110b may start to detect the sidelink PRS in the unlicensed spectrum at 426.

In response to the first LBT procedure ending successfully, the Tx UE 110a may transmit the sidelink PRS to the Rx UE 110b in the unlicensed spectrum at 428. In an example embodiment, the Tx UE 110a may transmit the sidelink PRS periodically during the channel occupancy time (COT) obtained through the first LBT procedure.

At 430, the Rx UE 110b may transmit a measurement report related to the sidelink PRS to the Tx UE 110a. The Rx UE 110b may transmit the measurement report in the licensed spectrum or in the unlicensed spectrum. Before transmitting the measurement report in the unlicensed spectrum, the Rx UE 110b may perform a Type 2 LBT procedure to confirm channel availability if the measurement report transmission is within the COT shared by the Tx UE 110a or perform a new Type 1 LBT procedure to obtain a new COT if the measurement report transmission is after the COT shared by the Tx UE 110a.

In the above example embodiments, the Tx UE 110a can dynamically determine an efficient sidelink PRS detection for the Rx UE 110b, and thus the Rx UE can detect the sidelink PRS promptly in the unlicensed spectrum with reduced complexity and power consumption. Since the PSFCH may be reused to inform the Rx UE of the LBT procedure ending at the Tx UE, the signaling overhead is not significantly increased between the Tx UE and the Rx UE.

In another example embodiment, the first LBT procedure (e.g. the Type 1 LBT procedure) may end before the preparation of the positioning related control information. At 418, the Tx UE 110a may transmit the positioning related control information to the Rx UE 110b using the selected sidelink resource in the licensed spectrum indicating the first LBT procedure ends. The Rx UE 110b may determine the timing for the sidelink positioning reference signal (PRS) detection based on the positioning related control information. In an example, the Rx UE 110b may decide to perform the sidelink PRS detection in the unlicensed spectrum immediately after it received the positioning related control information. In another example, the Rx UE 110b may decide to start performing the sidelink PRS detection in the unlicensed spectrum at the beginning of a slot (e.g., a NR slot) or a symbol within a slot (e.g., an OFDM symbol within a NR slot). The slot or the symbol is after the Rx UE 110b received the positioning related control information. Further, when the Tx UE 110a and the Rx UE 110b are in the same radio environment, the Rx UE 110b may perform an additional short/reduced LBT procedure (e.g., checks if the channel is idle for an additional duration of a defer period Ta) right before the slot or the symbol. The Rx UE 110b may start performing the sidelink PRS detection in the unlicensed spectrum at the beginning of the slot or the symbol after verifying the channel is idle for the duration.

In another example embodiment, the first LBT procedure is a Type 2 LBT procedure and the first LBT procedure is initiated after the operation 418. At 418, the Tx UE 110a may transmit the positioning related control information to the Rx UE 110b using the selected sidelink resource in the licensed spectrum indicating the first LBT procedure is a Type 2 LBT procedure. The Rx UE 110b may determine the timing for the sidelink positioning reference signal (PRS) detection based on the positioning related control information. In an example, the Rx UE 110b may decide to perform the sidelink PRS detection in the unlicensed spectrum immediately after it received the positioning related control information. In another example, the Rx UE 110b may decide to start performing the sidelink PRS detection in the unlicensed spectrum at the beginning of a slot (e.g., a NR slot) or a symbol within a slot (e.g., an OFDM symbol within a slot). The slot or the symbol is after the Rx UE 110b received the positioning related control information. Further, when the Tx UE 110a and the Rx UE 110b are in the same radio environment, the Rx UE 110b may perform an additional short/reduced LBT procedure (e.g., Type 2 LBT) right before the slot or the symbol. The Rx UE 110b may start performing the sidelink PRS detection in the unlicensed spectrum at the beginning of the slot or the symbol after verifying the channel is idle.

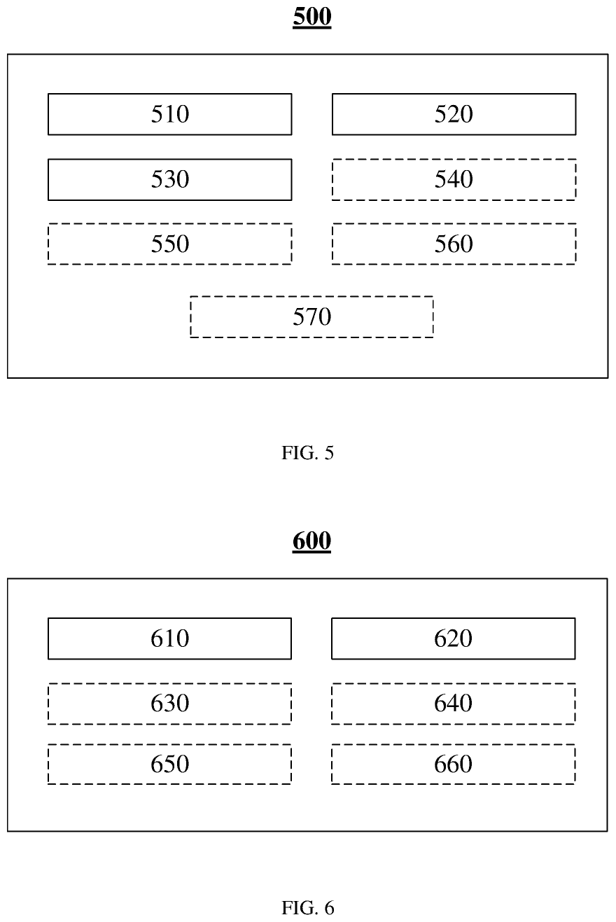

FIG. 5 is a schematic block diagram illustrating an apparatus 500 according to an example embodiment of the present disclosure. The apparatus 500 may be implemented at a terminal device like the Tx UE 110a to perform operations relating to the Tx UE 110a as discussed above. Since the operations relating to the Tx UE 110a have been discussed in detail with reference to FIGS. 1-5, the blocks of the apparatus 500 will be described briefly here and details thereof may refer to the above description.

As shown in FIG. 5, the apparatus 500 may include a first means 510, a second means 520 and a third means 530. The first means 510 may initiate a first listen before talk (LBT) procedure before the Tx UE 110a transmits a sidelink positioning reference signal (PRS) to the Rx UE 110b in an unlicensed spectrum during a sidelink positioning session. The second means 520 may transmit positioning related control information to the Rx UE 110b in a licensed spectrum. The positioning related control information may include an indication for the Rx UE 110b to receive a notification of whether the first LBT procedure initiated by the Tx UE 110a is successful or to perform a second LBT procedure. The third means 530 may transmit the sidelink PRS in the unlicensed spectrum in response to the first LBT procedure initiated by the Tx UE 110a ending successfully.

In an example embodiment, the indication for the Rx UE 110b to perform the second LBT procedure may include one or more parameters related to the first LBT initiated at the Tx UE 110a, so that the Rx UE 110b can perform the second LBT procedure synchronously with respect to the first LBT procedure performed at the Tx UE 110a. The one or more parameters related to the first LBT procedure may include at least one of starting or continuing time of the first LBT procedure, a backoff counter value of the first LBT procedure, a defer period of the first LBT procedure, an energy threshold for the first LBT procedure, or a channel access priority class for the first LBT procedure.

In an example embodiment, the positioning related control information is transmitted before the first LBT procedure ends.

In an example embodiment, the apparatus 500 may further include a fourth means 540 and a fifth means 550. The fourth means 540 may select a sidelink resource for transmitting the positioning related control information to the Rx UE 110b. The fifth means 550 may decide whether to notify the Rx UE 110b of whether the first LBT procedure is successful or to indicate the Rx UE 110b to perform the second LBT procedure, based on at least one of: progress of the first LBT procedure, a delay between the selected sidelink resource and a sidelink feedback channel resource associated with the selected sidelink resource, or radio environment of the Tx UE 110a and the Rx UE 110b.

In an example embodiment, the fifth means 550 may decide to notify the Rx UE 110b of whether the first LBT procedure is successful in a case where the delay between the selected sidelink resource and the sidelink feedback channel resource associated with the selected sidelink resource is longer than estimated remaining time of the first LBT procedure.

In an example embodiment, the fifth means 550 may decide to indicate the Rx UE 110b to perform the second LBT procedure in a case where the Tx UE 110a and the Rx UE 110b are in a same radio environment.

In an example embodiment, the apparatus 500 may further include a sixth means 560 for transmitting to the Rx UE 110b the notification of whether the first LBT procedure is successful on a sidelink feedback channel resource associated with the positioning related control information in a case where the positioning related control information comprises the indication for the Rx UE 110b to receive the notification.

In an example embodiment, the apparatus 500 may further include a seventh means 570 for determining whether the Tx UE 110a and the Rx UE 110b are in a same radio environment before transmitting the positioning related control information. In an example, the seventh means 570 determines the Tx UE 110a and the Rx UE 110b are in the same radio environment in a case where a distance between the Tx UE 110a and the Rx UE 110b is less than or equal to a threshold, or the Tx UE 110a and the Rx UE 110b obtain a same measurement result by measuring the unlicensed spectrum.

In an example embodiment, the first LBT procedure performed at the Tx UE 110a is a Type 1 LBT procedure, and the second LBT procedure performed at the Rx UE 110b is a Type 1 LBT procedure.

FIG. 6 is a schematic block diagram illustrating an apparatus 600 according to an example embodiment of the present disclosure. The apparatus 600 may be implemented at a terminal device like the Rx UE 110b to perform operations relating to the Rx UE 110b as discussed above. Since the operations relating to the Rx UE 110b have been discussed in detail with reference to FIGS. 1-5, the blocks of the apparatus 600 will be described briefly here and details thereof may refer to the above description.

As shown in FIG. 6, the apparatus 600 may include a first means 610 for receiving positioning related control information from the Tx UE 110a over sidelink in the licensed spectrum, and a second means 620 for performing sidelink positioning reference signal (PRS) detection in the unlicensed spectrum at a timing determined based on the positioning related control information. The positioning related control information may include an indication for the Rx UE 110b to receive a notification of whether a first LBT procedure initiated by the Tx UE 110a is successful or to perform a second LBT procedure.

In an example embodiment, the apparatus 600 may further include a third means 630 for receiving the notification of whether the first LBT procedure initiated by the Tx UE 110a is successful on a sidelink feedback channel resource associated with the positioning related control information in a case where the positioning related control information comprises the indication for the Rx UE 110b to receive the notification, and a fourth means 640 for determining the timing for the sidelink PRS detection when the received notification indicates the first LBT procedure initiated by the Tx UE 110a is successful.

In an example embodiment, the apparatus 600 may further include a fifth means 650 for performing the second LBT procedure in a case where the positioning related control information includes the indication for the Rx UE 110b to perform the second LBT procedure, and a sixth means 660 for determining the timing for the sidelink PRS detection when the second LBT procedure performed at the Rx UE 110b is successful. The indication for the Rx UE 110b to perform the second LBT procedure may include one or more parameters related to the first LBT procedure initiated by the Tx UE 110a. In an example embodiment, the one or more parameters related to the first LBT procedure may include at least one of starting or continuing time of the first LBT procedure, a backoff counter value of the first LBT procedure, a defer period of the first LBT procedure, an energy threshold for the first LBT procedure, or a channel access priority class for the first LBT procedure.

In an example embodiment, the first LBT procedure initiated by the Tx UE 110a is a Type 1 LBT procedure and the second LBT procedure performed at the Rx UE 110b is a Type 1 LBT procedure.

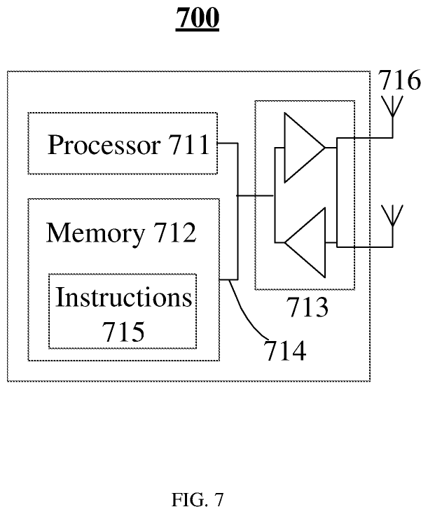

FIG. 7 illustrates a schematic block diagram of a device 700 according to an example embodiment of the present disclosure. The device 700 may be implemented as the Tx UE 110a and/or the Rx UE 110b discussed above.

Referring to FIG. 7, the device 700 may include one or more processors 711, one or more memories 712 and one or more transceivers 713 interconnected through one or more buses 714. The one or more buses 714 may be address, data, or control buses, and may include any interconnection mechanism such as series of lines on a motherboard or integrated circuit, fiber, optics or other optical communication equipment, and the like. Each of the one or more transceivers 713 may comprise a receiver and a transmitter, which are connected to one or more antennas 716. The device 700 may wirelessly communicate with a network device or a terminal device through the one or more antennas 716. The one or more memories 712 may include instructions 715 which, when executed by the one or more processors 711, may cause the device 700 to perform operations relating to the Tx UE 110a and/or operations relating to the Rx UE 110b as described above.

The one or more processors 711 may be of any appropriate type that is suitable for the local technical network, and may include one or more of general purpose processors, special purpose processor, microprocessors, a digital signal processor (DSP), one or more processors in a processor based multi-core processor architecture, as well as dedicated processors such as those developed based on Field Programmable Gate Array (FPGA) and Application Specific Integrated Circuit (ASIC). The one or more processors 711 may be configured to control other elements of the device 700 and operate in cooperation with them to implement the procedures discussed above.

The one or more memories 712 may include at least one storage medium in various forms, such as a volatile medium and/or a non-volatile medium. The volatile memory may include but not limited to for example a random access memory (RAM) or a cache. The non-volatile memory may include but not limited to for example a read only memory (ROM), a hard disk, a flash memory, and the like. Further, the one or more memories 712 may include but not limited to an electric, a magnetic, an optical, an electromagnetic, an infrared, or a semiconductor system, apparatus, or device or any combination of the above.

Some exemplary embodiments further provide computer program code or instructions which, when executed by one or more processors, may cause a device or apparatus to perform the procedures described above. The computer program code or instructions for carrying out procedures of the exemplary embodiments may be written in any combination of one or more programming languages. The computer program code or instructions may be provided to one or more processors or controllers of a general purpose computer, special purpose computer, or other programmable data processing apparatus, such that the program code or instructions, when executed by the processor or controller, cause the functions/operations specified in the flowcharts and/or block diagrams to be implemented. The program code or instructions may be executed entirely on a machine, partly on the machine, as a stand-alone software package, partly on the machine and partly on a remote machine or entirely on the remote machine or server.

Some exemplary embodiments further provide a non-transitory computer program product or a non-transitory computer readable medium having the computer program code or instructions stored therein. The term “non-transitory” as used herein is a limitation of the medium itself (i.e., tangible, not a signal) as opposed to a limitation on data storage persistency (e.g., RAM vs. ROM). The non-transitory computer readable medium may be any tangible medium that may contain or store a program for use by or in connection with an instruction execution system, apparatus, or device. The computer readable medium may be a computer readable signal medium or a computer readable storage medium. A computer readable medium may include but is not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

It would be understood that blocks in the drawings may be implemented in various manners, including software, hardware, firmware, or any combination thereof. In some embodiments, one or more blocks may be implemented using software and/or firmware, for example, machine-executable instructions stored in the storage medium. In addition to or instead of machine-executable instructions, parts or all of the blocks in the drawings may be implemented, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-Chip systems (SOCs), Complex Programmable Logic Devices (CPLDs), etc.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in a language that is specific to structural features and/or method actions, it is to be understood the subject matter defined in the appended claims is not limited to the specific features or actions described above. On the contrary, the above-described specific features and actions are disclosed as an example of implementing the claims.

1. A first terminal device in a radio access network comprising:
at least one processor; and
at least one memory storing instructions that, when executed by the at least one processor, cause the first terminal device at least to:
initiate a first listen before talk procedure before transmitting a sidelink positioning reference signal to a second terminal device in the radio access network in an unlicensed spectrum during a sidelink positioning session;
transmit positioning related control information to the second terminal device in a licensed spectrum, the positioning related control information comprising an indication for the second terminal device to receive a notification of whether the first listen before talk procedure initiated by the first terminal device is successful or to perform a second listen before talk procedure; and
transmit the sidelink positioning reference signal in the unlicensed spectrum in response to the first listen before talk procedure initiated by the first terminal device ending successfully.

2. The first terminal device of claim 1 wherein the positioning related control information is transmitted before the first listen before talk procedure initiated by the first terminal device ends.

3. The first terminal device of claim 1 wherein the at least one memory further stores instructions that, when executed by the at least one processor, cause the first terminal device at least to:
transmit to the second terminal device, the notification of whether the first listen before talk procedure initiated by the first terminal device is successful on a sidelink feedback channel resource associated with the positioning related control information, in a case where the positioning related control information comprises the indication for the second terminal device to receive the notification of whether the first listen before talk procedure initiated by the first terminal device is successful.

4. The first terminal device of claim 1 wherein the indication for the second terminal device to perform the second listen before talk procedure comprises one or more parameters related to the first listen before talk procedure initiated by the first terminal device.

5. The first terminal device of claim 4 wherein the one or more parameters related to the first listen before talk procedure initiated by the first terminal device comprise at least one of:
starting or continuing time of the first listen before talk procedure;
a backoff counter value of the first listen before talk procedure;
a defer period of the first listen before talk procedure;
an energy threshold for the first listen before talk procedure; or
a channel access priority class for the first listen before talk procedure.

6. The first terminal device of claim 1 wherein the at least one memory further stores instructions that, when executed by the at least one processor, cause the first terminal device at least to:
select a sidelink resource for transmitting the positioning related control information to the second terminal device; and
decide whether to notify the second terminal device of whether the first listen before talk procedure initiated by the first terminal device is successful or to indicate the second terminal device to perform the second listen before talk procedure, based on at least one of: progress of the first listen before talk procedure initiated by the first terminal device, a delay between the selected sidelink resource and a sidelink feedback channel resource associated with the selected sidelink resource, or radio environment of the first terminal device and the second terminal device.

7. The first terminal device of claim 6 wherein the first terminal device decides to notify the second terminal device of whether the first listen before talk procedure initiated by the first terminal device is successful in a case where the delay between the selected sidelink resource and the sidelink feedback channel resource associated with the selected sidelink resource is longer than estimated remaining time of the first listen before talk procedure initiated by the first terminal device.

8. The first terminal device of claim 6 wherein the first terminal device decides to indicate the second terminal device to perform the second listen before talk procedure in a case where the first terminal device and the second terminal device are in a same radio environment.

9. The first terminal device of claim 8 wherein the at least one memory further stores instructions that, when executed by the at least one processor, cause the first terminal device at least to:
determine whether the first terminal device and the second terminal device are in a same radio environment before transmitting the positioning related control information.

10. The first terminal device of claim 9 wherein the first terminal device determines the first terminal device and the second terminal device are in the same radio environment in a case where:
a distance between the first terminal device and the second terminal device is less than or equal to a threshold; or
the first terminal device and the second terminal device obtain a same measurement result by measuring the unlicensed spectrum.

11. The first terminal device of claim 1 wherein the first listen before talk procedure initiated by the first terminal device is a Type 1 listen before talk procedure and the second listen before talk procedure performed at the second terminal device is a Type 1 listen before talk procedure.

12. A second terminal device in a radio access network comprising:
at least one processor; and
at least one memory storing instructions that, when executed by the at least one processor, cause the second terminal device at least to:
receive positioning related control information from a first terminal device in the radio access network over sidelink in a licensed spectrum, the positioning related control information comprising an indication for the second terminal device to receive a notification of whether a first listen before talk procedure initiated by the first terminal device is successful or to perform a second listen before talk procedure; and
perform sidelink positioning reference signal detection in an unlicensed spectrum at a timing determined based on the positioning related control information.

13. The second terminal device of claim 12 wherein the at least one memory further stores instructions that, when executed by the at least one processor, cause the second terminal device at least to:
receive the notification of whether the first listen before talk procedure initiated by the first terminal device is successful on a sidelink feedback channel resource associated with the positioning related control information in a case where the positioning related control information comprises the indication for the second terminal device to receive the notification; and
determine the timing for the sidelink positioning reference signal detection when the received notification indicates the first listen before talk procedure initiated by the first terminal device is successful.

14. The second terminal device of claim 12 wherein the at least one memory further stores instructions that, when executed by the at least one processor, cause the second terminal device at least to:
perform the second listen before talk procedure in a case where the positioning related control information comprises the indication for the second terminal device to perform the second listen before talk procedure, wherein the indication for the second terminal device to perform the second listen before talk procedure comprises one or more parameters related to the first listen before talk procedure initiated by the first terminal device; and
determine the timing for the sidelink positioning reference signal detection when the second listen before talk procedure performed at the second terminal device is successful.

15. The second terminal device of claim 14 wherein the one or more parameters related to the first listen before talk procedure comprise at least one of:
starting or continuing time of the first listen before talk procedure;
a backoff counter value of the first listen before talk procedure;
a defer period of the first listen before talk procedure;
an energy threshold for the first listen before talk procedure; or
a channel access priority class for the first listen before talk procedure.

16. The second terminal device of claim 12 wherein the first listen before talk procedure initiated by the first terminal device is a Type 1 listen before talk procedure and the second listen before talk procedure performed at the second terminal device is a Type 1 listen before talk procedure.

17. A method implemented at a first terminal device in a radio access network comprising:
initiating a first listen before talk procedure before transmitting a sidelink positioning reference signal to a second terminal device in the radio access network in an unlicensed spectrum during a sidelink positioning session;
transmitting positioning related control information to the second terminal device in a licensed spectrum, the positioning related control information comprising an indication for the second terminal device to receive a notification of whether the first listen before talk procedure initiated by the first terminal device is successful or to perform a second listen before talk procedure; and
transmitting the sidelink positioning reference signal in the unlicensed spectrum in response to the first listen before talk procedure initiated by the first terminal device ending successfully.

18. The method of claim 17 wherein the positioning related control information is transmitted before the first listen before talk procedure initiated by the first terminal device ends.

19. The method of claim 17 further comprising:
transmitting to the second terminal device, the notification of whether the first listen before talk procedure initiated by the first terminal device is successful on a sidelink feedback channel resource associated with the positioning related control information, in a case where the positioning related control information comprises the indication for the second terminal device to receive the notification of whether the first listen before talk procedure initiated by the first terminal device is successful.

20. The method of claim 17 wherein the indication for the second terminal device to perform the second listen before talk procedure comprises one or more parameters related to the first listen before talk procedure initiated by the first terminal device.

21.-40. (canceled)
